(19) United States
(12) Patent Application Publication
(10) Pub. No.: US 2016/0130001 A1
(43) Pub. Date: May 12, 2016

(54) AERIAL DELIVERY SYSTEM

(71) Applicant: THE COOK FOUNDATION, Rarotonga (CK)

(72) Inventors: George COOK, Kent (GB); Jonathan COOK, Kent (GB); Michael COOK, Kent (GB)

(21) Appl. No.: 14/894,309

(22) PCT Filed: May 29, 2014
(86) PCT No.: PCT/GB2014/051642

§ 371 Date: Nov. 25, 2015

(30) Foreign Application Priority Data
May 29, 2013 (GB) 1309599.7

(51) Int. Cl. B64D 1/14; B64D 17/02; B64D 17/26; B64D 1/12

(52) U.S. Cl. CPC B64D 1/14; B64D 1/12; B64D 17/02; B64D 17/26

(57) ABSTRACT

An aerial delivery box for release from an aircraft comprises a hold for a payload; and an impact absorbing zone for protecting the payload of the hold. The hold and the impact absorbing zone are formed of biodegradable materials. The impact absorbing zone comprises at least one layer having a honeycomb structure, the honeycomb structure defining a cellular network extending in the plane of the layer. Also disclosed is an aerial delivery assembly comprising: the aerial delivery box; a parachute; and a plurality of shroud lines connecting the parachute to the aerial delivery box. Also disclosed is a method of delivering goods by aerial delivery, comprising releasing the aerial delivery assembly from an aircraft. The aerial delivery assembly may be released from a cargo pod of an aircraft, in particular a cargo pod comprising: a first casing attached to the aircraft; and a second casing attached to the first casing rearwardly of the first casing. The first and second casings define an opening to receive the assembly. The second casing is adapted to be releasable from the first casing so as to expose the parachute and thereby allow the parachute to inflate and extract the aerial delivery box from the first casing.

### FIELD OF THE INVENTION

The invention relates to the field of inexpensive and single-use aerial delivery systems.

### BACKGROUND OF THE INVENTION

Conventional aerial delivery systems have been developed to allow goods and personnel to be delivered to inaccessible or hard-to-reach locations. For example, emergency relief can quickly be delivered to regions which are cut-off from usual delivery routes or supplies can be safely delivered to resupply bases in hostile environments. Aerial delivery is advantageous because it allows these deliveries to be made with the minimum of risk and aerial delivery is often the fastest way of delivering goods to these areas.

Conventional aerial delivery systems generally comprise a platform, onto which the goods are secured, or a box, which is coupled to a parachute. The box or platform will then be dropped at a height from an aeroplane or helicopter above a target location, with the parachute slowing the descent of the package. The goods can subsequently be recovered at the target location.

Aerial delivery systems are capable of delivering a range of goods from personnel and heavy vehicles to small packages of medicines and the size of the system will depend on the size of the good being delivered and the method of delivery. For example, an aerial delivery system for a heavy load will require a large parachute or multiple parachutes so as to avoid damage to the goods or the landing zone. The most common forms of aerial delivery using parachutes include high-velocity and low-velocity gravity drops and low-altitude parachute extraction (LAPES). In other cases, such as freedrop delivery, no parachute is used and the packaging protects the goods being delivered.

In most aerial delivery systems, to prevent damage to the goods, the platform or box of an aerial delivery system will normally utilise an impact-absorbing system located on the face of the platform or box that is most likely to impact the ground first. Common impact-absorbing systems include inflatable airbags, collapsible layers of corrugated cardboard or plastic or cushions formed from foams. The size and construction of these impact-absorbing systems will depend on the speed of descent, the weight of the package, the impact-resistance of the goods and many other factors. In many cases the impact will result in damage to or destruction of the impact-absorbing system, as the impact-absorbing nature comes from its ability to act as a crumple zone.

In many cases, aerial delivery systems are only used once as the recovery of parachutes and packaging can be too expensive or too dangerous to make recovery viable. This can add substantial cost to the cost of delivering goods by aerial delivery and make it an expensive method of transporting goods. This also has a substantial environmental impact as significant resources are not recovered or re-used and can damage or blight the environment. For example, the majority of parachutes are manufactured from nylon and the boxes or platforms in an aerial delivery system from plastic, wood or metal and, therefore, could be re-used multiple times if recovered.

Traditionally, aerial delivery systems are dropped from large aeroplanes, such as the widely used C-130 Hercules aeroplane, or helicopters. The use of large aircraft greatly limits the situations where aerial delivery can be used. Firstly, it adds significant financial costs to the delivery due to the costs of obtaining said aircraft and the costs of running the aircraft and in many cases, there are no aircraft of a suitable size available. It also limits the locations supplies can be delivered from and delivered to due to a lack of suitable airfields, planes and unpredictable weather.

### SUMMARY OF THE INVENTION

According to the invention, there is provided an apparatus, method and use as defined in the independent claims.

A first aspect of the invention provides an aerial delivery box for release from an aircraft comprising a hold for a payload; an impact absorbing zone for protecting the payload of the hold; wherein the hold is formed of a biodegradable material; and wherein the impact absorbing zone comprises at least one layer having a honeycomb structure formed of a biodegradable material, the honeycomb structure defining a cellular network extending in the plane of the layer. For example, the biodegradable material may be paper, cardboard or any other woodpulp material; cotton; biodegradable plastic (e.g. Polylactic acid or cellulose); or any other biodegradable material.

By biodegradable, it is meant that materials can be decomposed by microorganisms, in particular by bacteria. The invention in this aspect provides an inexpensive and lightweight box providing means for containing and protecting a package for aerial delivery. The invention provides a hold for containing the goods, the hold being protected by an impact absorbing zone comprising at least one layer of honeycomb-structured biodegradable material. In this aspect of the invention the impact absorbing zone is suitable for protecting the contents of the hold from impact while still having a low environmental impact.

The invention in this aspect further provides means for the delivery of goods wherein the packaging is biodegradable. Accordingly, failure to recover the aerial delivery box will not damage the environment, nor will it be an unnecessary waste of resources, as the box can be designed to be single-use. Moreover, in an embodiment, the packaging can be manufactured from recycled materials thereby reducing the impact further. In addition, in another embodiment the materials involved can be inexpensive and delivery can be achieved for significantly less.

The invention in this aspect further provides an effective way of protecting the hold. A honeycomb-structured layer has a structure that will protect the goods in the hold such that it can resist impact but also deform when the force reaches a threshold, thus allowing it to absorb the force of the impact and crumple.

The use of a layer having a honeycomb structure further provides the advantage of improved safety by potentially reducing the damage to the landing zone and objects within the landing zone. In addition, the typical low cost nature of the invention in this aspect reduces reliance on aerial delivery methods that would cause significant damage upon impact to the landing zone and objects within the landing zone, for example, aerial delivery methods that do not use a parachute (e.g. due to cost).

In an embodiment the impact absorbing zone comprises at least two layers, each layer comprising a honeycomb structure; and the layers are arranged such that the honeycomb structure are out of alignment with the honeycomb structure of the adjacent layers and/or are separated by sheets of material formed of a biodegradable material. For example, the biodegradable material may be paper, cardboard or any other woodpulp material; cellulose; cotton; biodegradable plastic such as Polylactic acid (PLA); or any other biodegradable material. By having the layers out of alignment, the strength of the impact absorbing zone is increased compared to if the honeycomb structures were aligned. This increases the impact absorbing ability of the landing buffer.

In another embodiment the impact absorbing zone comprises at least two layers, each layer comprising a honeycomb structure; and the layers are separated by a void space. By having a gap between the layers of honeycomb-structured material, the impact absorbing zone is able to deform and crumple to a greater extent. This reduces the likelihood that the force of the impact will travel through the impact absorbing zone and damage the contents of the hold.

In another embodiment, the honeycomb structured layer of is formed of cardboard. In this aspect of the invention the impact absorbing zone is suitable for protecting the contents of the hold from impact while still remaining lightweight and inexpensive with a low environmental impact. The invention in this aspect further provides a cheap and effective way of protecting the hold. Honeycomb-cardboard is a very effective and inexpensive load-bearing material. The structure of the honeycomb cardboard provides it with sufficient strength such that it can resist impact but also deform when the force reaches a threshold, thus allowing it to absorb the impact of the force and crumple.

In another embodiment, the hold is formed of cardboard, paper or woodpulp, in particular the hold is a corrugated cardboard box. The invention in this aspect provides an inexpensive and lightweight box providing means for containing and protecting a package for aerial delivery. The lightweight nature and the structure of the aerial delivery box, as well as the inexpensive nature of the materials, improves the safety of the aerial delivery of goods by

The invention in this aspect provides an assembly for safely delivering goods by aerial delivery. The lightweight nature and structure of the aerial delivery box means that damage to the landing zone and objects within the landing zone upon impact is reduced and less severe. Moreover, the relatively inexpensive nature of the aerial delivery assembly, and its low environmental impact, reduces reliance on aerial delivery methods that cause significant damage, for example, aerial delivery methods that do not use a parachute (e.g. due to cost).

In another embodiment, the box is covered with a waterproofing material to protect the box and the supplies therein. In another embodiment, the waterproofing material is a wax, in particular a clean-burning wax or a polymer coating of nano-scale thickness, allowing the box to be safely burned. The term “nano-scale thickness” means a thickness of 1 nm to 10000 nm, preferably 1 nm to 1000 nm thick, more preferably 1 nm to 500 nm thick. For example, the polymer coating may be a hydrophobic polymer coating such as ethylcellulose.

In the embodiments above, the honeycomb-structured biodegradable material can comprise honeycomb geometries of any shape including hexagonal, circular, triangular or square or combinations thereof.

A second aspect of the invention provides an aerial delivery assembly comprising an aerial delivery box according to the first aspect of the invention; a parachute; and a plurality of shroud lines connecting the parachute to the aerial delivery box. The invention in this aspect provides an inexpensive system for delivering goods by aerial delivery.

In one embodiment the parachute is formed of a biodegradable material. Both the parachute and the box are comprised of materials that are biodegradable and therefore have a low environmental impact when used. In an embodiment, these may also be safely combustible or recyclable.

In another embodiment the parachute consists essentially of a biodegradable material. The term “consists essentially of . . . ” means that the parachute (or box or shroud lines) is almost entirely formed from a biodegradable material, but may contain minor quantities of other materials. For example, it may be formed from 85% or greater biodegradable materials (by weight or by volume), preferably 90% or greater, more preferably 95% or greater or even more preferably 99% or greater biodegradable materials. ‘Essentially all’ or ‘substantially all’ means that the vast majority or almost all of the parachute (or box or shroud lines) will biodegrade but minor quantities of other materials may remain or may not be able to biodegrade. For example, 85% of the parachute may biodegrade, preferably 90% or greater, more preferably 95% or greater or even more preferably 99% or greater of the parachute will biodegrade.

In one embodiment the biodegradable material is paper or another woodpulp derivative. Both the parachute and the box are comprised of materials that can be safely burned, recycled or are biodegradable. Moreover, a parachute comprising a material made from woodpulp can be designed to be single-use without being expensive, an inefficient use of resources or harmful to the environment.

For example, the parachute may consist exclusively of paper or a woodpulp derivative. Accordingly, essentially all of the parachute can be recycled or, if left unrecovered, will quickly degrade. In another embodiment, the parachute is treated with a waterproofing material and/or reinforced, in particular with plastic or paper reinforcements. These provide the parachute with the necessary strength to withstand the forces applied during the descent of the parachute.

In another embodiment, the plurality of shroud lines are formed of a biodegradable material. In another embodiment, the plurality of shroud lines consist essentially of a biodegradable material. In another embodiment, the biodegradable material is paper or another woodpulp derivative.

In another embodiment, the assembly is adapted for deployment from a cargo pod of a light aircraft, the cargo pod comprises a first casing attached to the aircraft and a second casing attached to the first casing rearwardly of the first casing, wherein the first and second casings define an opening to receive the assembly; and wherein the second casing is adapted to be releasable from the first casing so as to expose the parachute and thereby allow the parachute to inflate and extract the aerial delivery box from the first casing. The use of this system allows delivery of the aerial delivery box to places where large aircraft cannot deliver, for example due to the cost of reaching these regions, lack of available airfields where these aircraft could land or, more commonly, because there are no large aircraft available.

In another embodiment, at least one of the shroud lines is configured such that when a load is applied the force is at least partially normalised and/or at least a portion of one shroud line is releaseably secured in a gathered formation such that when tension is applied the shroud line is lengthened. The gathered formation means that the shroud lines can be folded or collected.

In a third aspect of the invention, the aerial delivery assembly of the second aspect of the invention is used to deliver a package.

In a fourth aspect of the invention, the parachute of the aerial delivery assembly of the second aspect of the invention is used to construct a personnel shelter.

In a fifth aspect of the invention, a method of delivering goods by aerial delivery comprises releasing the aerial delivery assembly of the second aspect of the invention from an aircraft. This allows the assembly to be delivered to any location that is accessible by a suitable aircraft.

In one embodiment, the aerial delivery assembly is released from a cargo pod of an aircraft, the cargo pod comprises a first casing attached to the aircraft and a second casing attached to the first casing rearwardly of the first casing, wherein the first and second casings define an opening to receive the assembly; and wherein the second casing is adapted to be releasable from the first casing so as to expose the parachute and thereby allow the parachute to inflate and extract the aerial delivery box from the first casing.

### BRIEF DESCRIPTION OF THE DRAWINGS

Specific embodiments of the invention will now be discussed in detail with reference to the accompanying drawings, in which:

FIG. 1 shows an embodiment of the present invention;

FIG. 2a shows the impact absorbing layer of an embodiment of the present invention;

FIG. 2b shows a honeycomb-structured cardboard layer;

FIG. 3 shows an embodiment of the present invention;

FIG. 4 shows an embodiment of the present invention;

FIGS. 5a-c show a release system;

FIG. 6 shows an embodiment of the present invention;

FIG. 7 shows a shock-mitigation arrangement;

FIG. 8 shows a shock-mitigation arrangement; and

FIG. 9 shows a shock-mitigation arrangement.

### DETAILED DESCRIPTION

The invention provides an apparatus, method and use of said apparatus for supply of goods by aerial delivery. The apparatus comprises a box or container for holding the goods to be delivered and a parachute system. The container is manufactured from biodegradable materials and is connected via shroud lines to the parachute. The parachute can also be manufactured from a biodegradable material and is used to slow the descent of the container. The container further comprises an impact absorbing zone in the form of a landing buffer, located on the face of the container that is intended to be impacted upon. The landing buffer is made from at least one layer of a material having a honeycomb-structure and is formed of a biodegradable material.

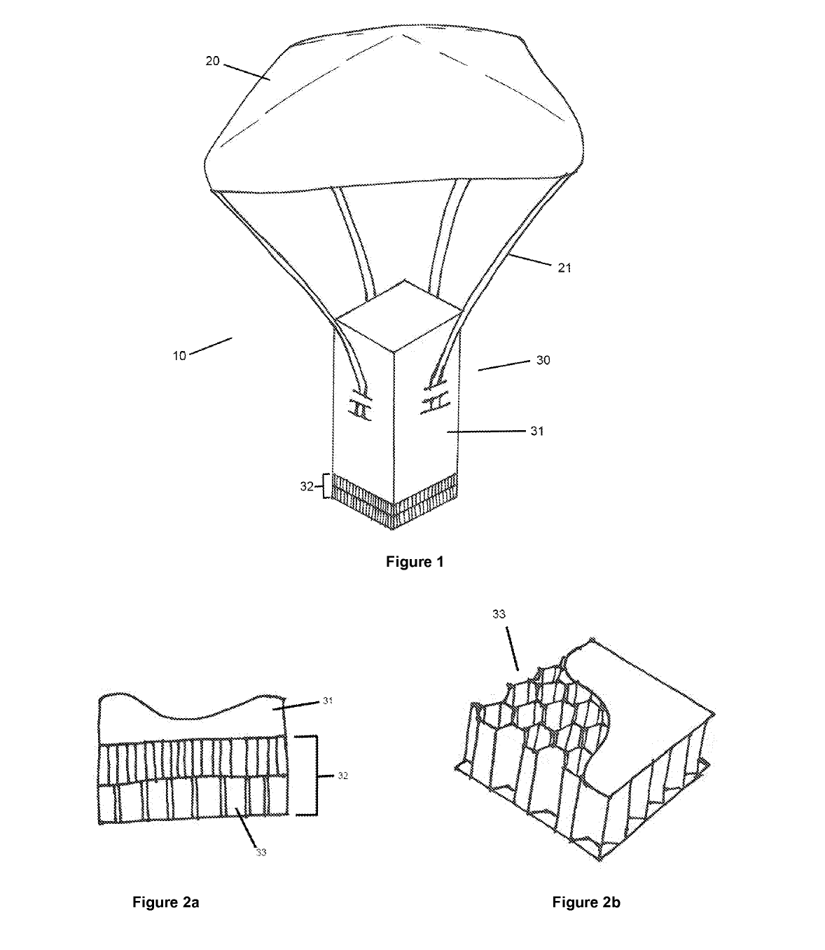

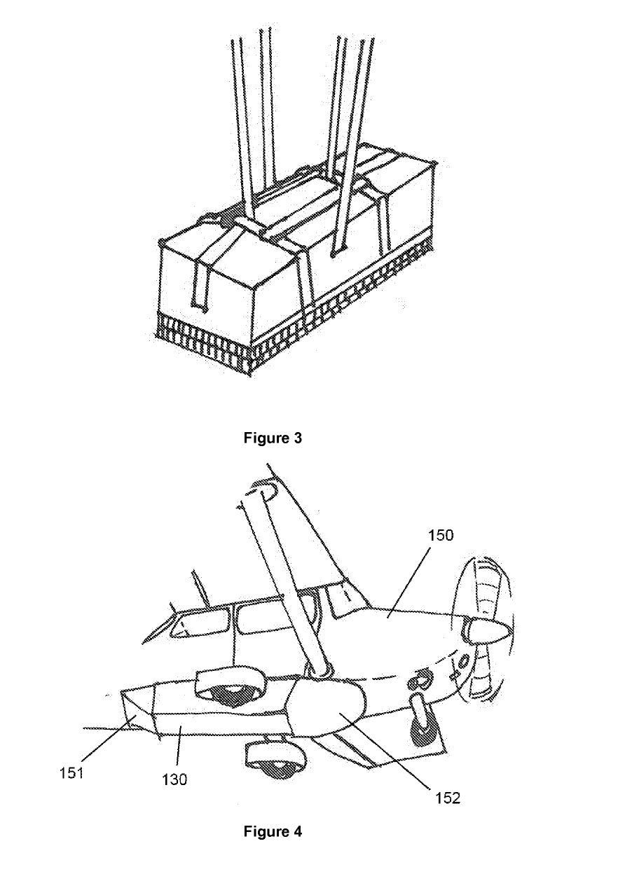

A first embodiment of the invention is shown in FIG. 1. The air drop system 10 comprises an air drop box 30 having an outer housing 31 and an impact absorbing zone 32. Within the outer housing 31 is an inner hold 34 (see FIG. 6) in which the goods for delivery can be stored. The outer housing 31 of the air drop box 30 consists essentially of corrugated cardboard. The use of corrugated cardboard means that the box is both lightweight and structurally strong. A reduced weight means that the box can be delivered using a smaller parachute and uses fewer resources in manufacture. In the first embodiment the box is a rectangular cuboid and is oriented such that the lower face of the box (i.e. the face most likely to impact the ground first) is a square face. However, alternative embodiments include the box oriented such that a rectangular face is the lower face (see FIG. 3), for example, if the load was a particularly heavy load. This orientation increases the size of the impact absorbing zone 32 and therefore provides more protection for the goods. In additional embodiments, the box can be formed of multiple layers of corrugated cardboard and/or can be covered in a clean-burning natural wax or a polymer coating having a nano-scale thickness to provide waterproofing.

The impact absorbing zone 32 of the air drop box 30 is located on the lower face of the box and comprises two layers of honeycomb structured cardboard 33, as shown in FIGS. 2a and 2b. The honeycomb structure defines a cellular network extending in the plane of the layer. The walls of the cells are oriented perpendicular to the plane of the layer and in one embodiment the cells are hexagonal in shape. The impact absorbing zone 32 acts as a landing buffer to absorb the shock caused when the box impacts a surface, preferably the target location, thereby reducing damage to the air drop box 30 and the goods inside the box. In this embodiment, the impact absorbing zone 32 is formed of two layers of honeycomb-structured cardboard 33. Honeycomb-structured cardboard 33 is particularly suited to this application as it has a high load-bearing strength relative to its weight but it is still able to deform and therefore absorb energy on impact. In alternative embodiments, the side walls of the air drop box 30 may also be reinforced with honeycomb-structured cardboard 33 to protect the goods from damage in the event that the box 30 rolls onto its side after impact.

In the first embodiment of the invention, the air drop box 30 is connected to a square canopy parachute 20 by shroud lines 21, the parachute 20 and shroud lines 21 consisting essentially of a tear-resistant wood pulp derivative material, for example air-laid paper. The size of the canopy of the parachute 20 required for the aerial delivery box 30 will primarily depend on the weight, size and fragility of the goods being delivered. A larger parachute 20 will reduce the speed of descent of the system 10. In this embodiment, the system 10 is released from a launch vehicle using parachute extraction as this significantly reduces the forces exerted on the parachute canopy and shroud lines 21. The use of parachute extraction enables the initial snatch force when the parachute 20 catches the air to be controlled by the airspeed of the launch vehicle. Therefore, by reducing airspeed during delivery, the initial snatch force can be substantially reduced. Using parachute extraction also means that the snatch force is separated from the deceleration load, in that the snatch force occurs well before the force experienced when the parachute 20 slows the initial falling speed of the box 30, thereby reducing the total force exerted at the initial drop. In addition, the deceleration load is applied over a longer period of time than would otherwise be experienced with standard drop methods, as the shroud lines 21 are already under tension when the box 30 moves from being in the same horizontal plane as the parachute 20, to being in the same vertical plane as the parachute 20. Additionally, as the parachute 20 is already open when it takes the weight of the box 30, it reduces the distance the load has to fall and accelerate before the parachute takes the full weight, thereby reducing the initial velocity of the system. This allows for the use of a parachute with less reinforcement than might otherwise be required in a system using a standard air drop release method. However, other embodiments of the invention include delivering the aerial delivery system 10 of the first embodiment by other methods of aerial delivery release.

Further ways to reduce peak stress on the parachute 20 and shroud lines 21 include using a smaller parachute. The use of a smaller parachute will depend on the mass of the package, the goods being delivered and the impact absorbing zone as use of a smaller parachute will inevitably result in an increase in the velocity at which the system 10 falls. Therefore, it can only be used if the package will be successfully delivered without being damaged on impact.

In the first embodiment, reinforcement of the canopy and shroud lines may be required, depending on the force to be applied to the load. The higher the force, the higher the strain along the edges of the canopy and the point at which the canopy attaches to the shroud lines 21 will be. It is along these high stress points that the parachute 20 may require reinforcement. In addition to reinforcing the parachute 20 and shroud lines 21 with additional wood-pulp material, other materials such as cotton or clean-burning or recyclable high-tensile polymers may be used.

In another embodiment, the parachute 20 may also include a vent (not shown) to increase stability. In this embodiment, reinforcing lines across the parachute 20 from the shroud lines 21 to the centre of the parachute may be used to reduce shear forces.

In a further embodiment substantially all of the delivery system 10 can be used as fuel for a fire. As the box 30 comprises corrugated cardboard walls it can be safely and cleanly burned and therefore is suited to use as kindling and as a fuel. Likewise, the parachute and shroud lines can be safely burned as they are manufactured from paper and optionally reinforced with cotton and clean burning high-tensile polymers. This is particularly advantageous in situations where the load being delivered is food or emergency supplies. For example, in an emergency relief situation an embodiment of the invention, in which substantially all of the aerial delivery assembly 10 can be cleanly burned, a delivery of food could be made to an emergency relief camp by aerial delivery. The goods delivered would provide food to the inhabitants of the camp and the aerial delivery box used to provide warmth and/or heat the food or just to provide kindling to start a more substantial fire. In this embodiment the aerial delivery assembly 10 provides a complete package for providing emergency supplies and relief, without a significant expenditure or environmental impact. Furthermore, should the packages not be burned, they can simply be recycled or left to biodegrade and therefore have a very minimal environmental impact in the event that they are not burned.

In another embodiment, the aerial delivery system 10 comprises a box 30 manufactured consisting essentially of corrugated cardboard with an impact absorbing zone 32 comprising honeycomb-structured cardboard. The box 30 is connected to a parachute 20, which is manufactured consisting essentially of an in-expensive biodegradable and recyclable plastic, for example a Polylactic acid (PLA). PLA has the advantages of being relatively cheap, strong and produced using environmentally friendly resources, while being clean burning. Furthermore, PLA can be woven into textile form to strengthen the parachute. This allows the aerial delivery system 10 to be recycled and thus reduces wastage and environmental impact. Furthermore, the use of inexpensive cardboard and plastic components means that the system is a low cost option for the delivery of goods compared to other aerial delivery methods and while having a low environmental impact. In this embodiment, the box can be burned, recycled or left to biodegrade and the plastic parachute can be recycled, burned or left to biodegrade. This has a significantly lower environmental impact than the aerial delivery systems of the prior art. The plastic parachute may also require reinforcement, depending on the goods being delivered. This can be achieved in a similar way to the paper parachute of the first embodiment. In this embodiment, the box 30 is wrapped in a recyclable plastic film (not shown) prior to delivery to provide waterproofing.

In additional embodiments, the impact absorbing zone may be arranged in different configurations to that of the first embodiment. For example, there may be three or more layers of honeycomb-structured cardboard, with each layer being located out of alignment with the adjacent layers. By increasing the layers of honeycomb cardboard additional resistance is provided against the impact and therefore the impact absorbing layer can absorb more damage. In each of these embodiments there may also be hollows formed between the layers giving the impact absorbing layer regions in which to compress onto itself. This allows the impact absorbing zone to absorb the impact of the drop without transferring a significant amount of energy to the hold of the box or the goods within the hold. In one embodiment, the impact absorbing zone is formed with an outside wall formed of corrugated cardboard. Within the impact absorbing zone are three layers of honeycomb-structured cardboard, each being spaced apart from one another thus defining a hollow therebetween. Each layer is connected to the corrugated cardboard of the box to maintain its location relative to the other layers prior to impact. In an alternative embodiment, the impact absorbing zone comprises two layers of honeycomb-structured cardboard with a number of spacers formed therebetween. The spacers maintain a distance between the first and second layers and are formed of small layers of honeycomb-structured cardboard.

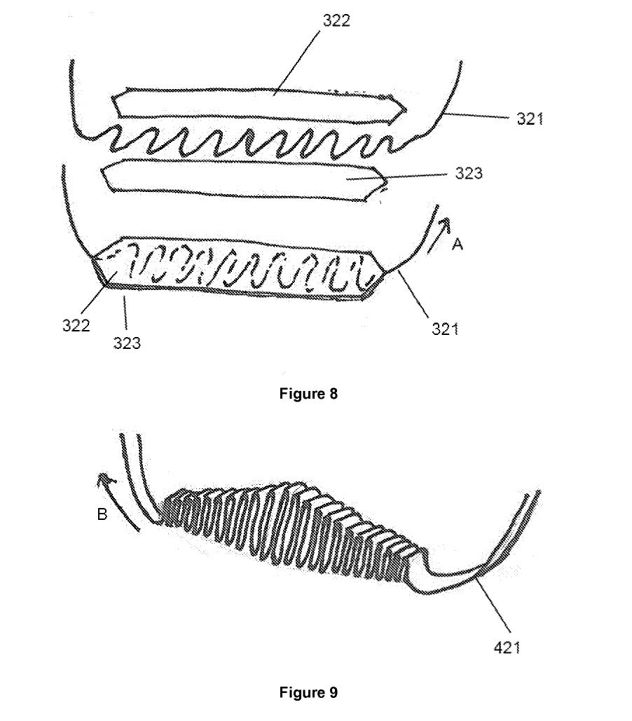

In further embodiments of the invention, the shroud lines are arranged such that when a force is applied, i.e. when the parachute is inflated and/or when the parachute slows the fall of the air drop box, a shock-absorbing feature reduces the strain on the shroud lines and at least partially reduces the peak force the shroud lines experience, in other words they normalise the force. One such embodiment is illustrated in FIGS. 7a and 7b. In FIG. 7a the aerial delivery box 230 is connected to shroud lines 221, which run through the impact absorbing layer 232. The impact absorbing layer is formed of two layers of honeycomb-structured cardboard 233,235 with a gap formed therebetween 234. The shroud lines 221 run through the gap 234 in the impact absorbing layer 232, with the honeycomb cardboard layer 233 located between the portions of the shroud lines 221 which pass through the impact absorbing zone 232 and the hold of the air drop box 230. The shroud lines 221 are also secured at a second point on the air drop box 230, near the top of the box 230 (not shown) to stabilise the package during descent. This arrangement enables the upper honeycomb layer 233 to absorb some of the force the shroud lines experience when either the parachute is inflated (i.e. when experiencing snatch force) or when the deceleration force is applied by deforming (as shown in FIG. 7b). The edges of the upper honeycomb layer 233 are most likely to deform due to the additional tension where the shroud lines 221 enter the impact-absorbing area 232 and therefore the majority of the upper layer 233 will remain intact for landing.

A further embodiment including a shroud line shock-absorbing feature is shown in FIG. 8, in particular for use with thinner shroud lines such as narrow straps or chords. In the embodiment shown in FIG. 8, shroud line 321 is a chord. A portion of the chord 321 is wound in a sinusoidal arrangement and secured between an upper and lower sheet of paper 322, 323, but 322 and 323 can be any destructible matrix. When a force A is applied to the chord 321 the paper is torn as the chord unwinds. The paper therefore provides some resistance to force A and reduces the force experienced by the chord 321.

A further embodiment including a shroud line shock-absorbing feature is shown in FIG. 9. In this embodiment, a portion of the shroud line 421 is folded over on itself several times and bonded together with an adhesive (other embodiments may include stitching or other securing means), the adhesive's bonding strength being weaker than the tensile strength of the shroud line 421. When a force strong enough to pull apart the folded layers of shroud line 421 is applied, e.g. force A, the folded shroud line portion unravels, with the adhesive providing resistance to lessen the force experienced by the shroud lines 421. These embodiments enable the use of weaker shroud lines 421,321,221,21 and, if reinforcement is required, less reinforcement will be necessary. This reduces the material requirements of the aerial delivery system.

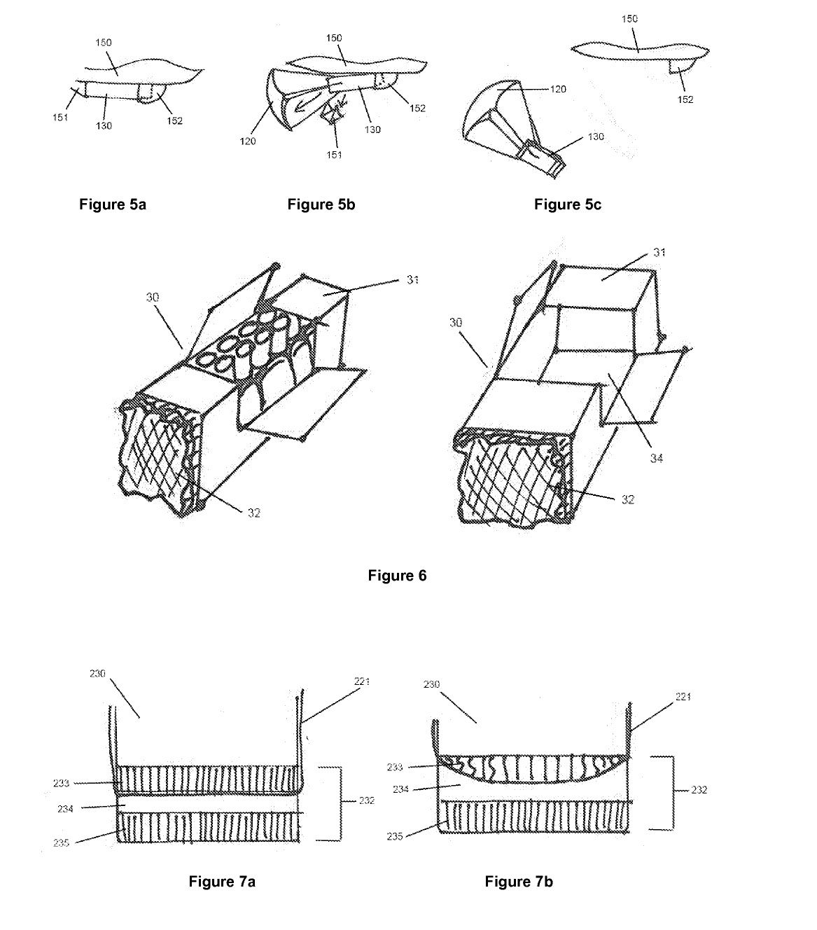

In the embodiment of FIG. 4, the aerial delivery box 130 is delivered by means of a light aircraft 150. This is achieved using a cargo pod located on an under body mount on the underside of the light aircraft 150. The cargo pod comprises a front casing 152 and a detachable rear casing 151. The aerial delivery box 130 is secured between the front and rear casings 152, 151 and is at least partially covered by each casing. As shown in FIGS. 5a to 5c, when the light aircraft 150 reaches the target destination the detachable rear casing 151 is released, which releases the parachute 120. This enables the parachute 120 attached to the aerial delivery box 130 to unfold and inflate thereby extracting the aerial delivery box 130 from the front casing 152 and releasing the aerial delivery system from the aircraft 150. Release of the aerial delivery system using this method is particularly advantageous as the release of the box 130 is substantially the same as a standard parachute extraction method and therefore has the same advantages as parachute extraction over other methods, as discussed above. In addition, the use of this system allows the aerial delivery box 130 to be delivered to places where large aircraft cannot deliver, for example due to the cost of reaching these regions, lack of available airfields where these aircraft could land or, more commonly, because there are no large aircraft available. This is particularly relevant to emergency relief in regions where there are many small aircraft but little to no available large aircraft. In particular, many emergency relief organisations have fleets of small planes, but no larger aircraft such as the Hercules C-130. Delivery using the cargo pod of this embodiment would be particularly suited to small packages, such as the delivery of medical goods.

Alternatively, the cargo pod may have a bomb-bay door. In other words, the cargo pod has two doors, which close together to form a closed hold. The assembly is held within the hold until it is to be dropped. The doors are then opened by releasing a lock and the assembly falls under gravity. In one embodiment, the parachute would be released by a tether, the tether being attached to the cargo pod so as to extract the parachute as the assembly falls. The tether is of a length such that when the assembly is sufficiently far from the cargo pod, the parachute is released.

Other variations to the disclosed embodiments can be understood and effected by those skilled in the art in practicing the claimed invention, from a study of the drawings, the disclosure, and the appended claims. For example, in the examples above:

a parachute can be of any shape including round, a square, conical, hexagonal, triangular or regular or tapered ram-air parachutes or any other shape of parachute and it is not limited to a single parachute;

the aerial delivery box can be released from the aircraft using any extraction means including parachute extraction, low-altitude parachute extraction, gravity drop or by any other means; and

the honeycomb-structured biodegradable material can comprise honeycomb geometries of any shape including hexagonal, circular or square.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1-28. (canceled)

29. An aerial delivery box for release from an aircraft comprising:
a hold for a payload; and
an impact absorbing zone for protecting the payload of the hold;
wherein the hold and the impact absorbing zone are formed of biodegradable materials; and
wherein the impact absorbing zone comprises at least one layer having a honeycomb structure, the honeycomb structure defining a cellular network extending in the plane of the layer.

30. The aerial delivery box of claim 29, wherein:
the impact absorbing zone comprises at least two layers, each layer having a honeycomb structure; and
the layers are arranged such that the honeycomb structures of the layers are out of alignment with the honeycomb structures of the adjacent layers and/or separated by sheets of material formed of a biodegradable material.

31. The aerial delivery box of claim 29, wherein:
the impact absorbing zone comprises at least two layers, each layer having a honeycomb structure; and
the layers are separated by a void space.

32. The aerial delivery box of claim 29, wherein the at least one layer having a honeycomb structure is formed of cardboard.

33. The aerial delivery box of claim 29, wherein the hold is formed of cardboard, paper or woodpulp, in particular wherein the hold is a corrugated cardboard box.

34. The aerial delivery box of claim 33, wherein the hold is covered with a waterproofing material.

35. The aerial delivery box of claim 29, wherein the hold comprises a plurality of outer walls which define an enclosure for receiving a payload; and wherein the impact absorbing zone comprises an impact absorbing structure arranged over at least one of the outer walls.

36. An aerial delivery assembly comprising:
an aerial delivery box according to claim 29;
a parachute; and
a plurality of shroud lines connecting the parachute to the aerial delivery box.

37. The aerial delivery assembly of claim 36, wherein the parachute is formed of a biodegradable material.

38. The aerial delivery assembly of claim 36, wherein the biodegradable material is paper or another woodpulp derivative or wherein the biodegradable material is a biodegradable plastic material.

39. The aerial delivery assembly of claim 36, wherein the parachute is treated with a waterproofing material and/or reinforced, in particular with plastic or paper reinforcements.

40. The aerial delivery assembly of claim 36, wherein the plurality of shroud lines are formed of a biodegradable material.

41. The aerial delivery assembly of claim 40, wherein the biodegradable material paper or another woodpulp derivative or wherein the biodegradable material is a biodegradable plastic material.

42. The aerial delivery assembly of claim 36, wherein at least one of the shroud lines is arranged such that, when a tension is applied, at least a portion of the impact absorbing zone is deformed by the shroud line.

43. The aerial delivery assembly of claim 36, wherein at least one of the shroud lines is arranged such that, when a tension is applied, the force is at least partially normalised and/or wherein at least a portion of one shroud line is releaseably secured in a gathered formation such that, when a tension is applied, the shroud line is lengthened.

44. The aerial delivery assembly of claim 36, wherein the parachute is arranged to be converted into a personnel shelter and optionally wherein at least a portion of the aerial delivery box is arranged to function as at least a portion of the structure of the shelter.

45. The aerial delivery assembly according to claim 36, wherein the delivery assembly is adapted for release from an aircraft using parachute extraction.

46. Use of the aerial delivery assembly of claim 36 to deliver a package.

47. Use of the parachute of the aerial delivery assembly of claim 36 to construct a shelter.

48. A method of delivering goods by aerial delivery, comprising:
releasing the aerial delivery assembly of claim 36 from an aircraft.
